(19) United States
(12) Patent Application Publication
(10) Pub. No.: US 2026/0219911 A1
(43) Pub. Date: Jul. 30, 2026

(54) EXTENDING UNCHANGED REGIONS OF FILESYSTEM RECIPES CONSTRAINED BY FIXED CHANGED BLOCK TRACKING (CBT) GRANULARITY

(71) Applicant: Dell Products L.P., Round Rock, TX (US)

(72) Inventors: Salil Dangi, Mission Viejo, CA (US); Nitin Madan, San Jose, CA (US); Donna Barry Lewis, Holly Springs, NC (US)

(21) Appl. No.: 19/041,425

(22) Filed: Jan. 30, 2025

(51) Int. Cl. G06F 9/455

(52) U.S. Cl. CPC G06F 9/45558; G06F 2009/45562

(57) ABSTRACT

Optimizing filesystem recipes for VM backups using variable size segmenting (VSS) by identifying a region of a VM to be copied having an unchanged data area bounded by left and right regions of real changed data. A changed block tracking (CBT) process marks a CBT region as changed data, but this area is greater than the regions of real changed data. A process identifies areas within respective CBT regions that have unchanged data but that is marked as changed data by the CBT process. It extends a recipe specifying unchanged data of a base file for replication to include the identified areas so as to prevent replication of data that is actually unchanged but marked as changed by the CBT process.

### TECHNICAL FIELD

Embodiments relate to deduplication backup systems, and specifically to expanding the granularity of filesystem recipe information when creating VM backups.

### BACKGROUND OF THE INVENTION

Data deduplication is a form of single-instance storage that eliminates redundant copies of data to reduce storage use. Data compression methods are used to store only unique instances of data by replacing redundant data blocks with pointers to the unique copies. As new data is written, duplicate chunks are replaced with these pointer references to previously stored data. Deduplication systems support various different backup operations such as full, differential, and incremental backups. A synthetic backup is the process of generating a file from a complete copy of a file created in the past and one or more incremental copies created later, and backups may be referred to as virtual synthetic backups of these various backup types.

In a typical virtual machine (VM) backup environment, the backup software uses a changed block tracking (CBT) process of the hypervisor to identify the changes in the storage system for the data it is trying to protect. In this way, the synthetic backup can be configured to generate incremental backups for only changed data and integrate these with data that is unchanged, such as from a last full backup. A CBT system, however, tracks changes at a certain granularity. For example, the granularity may be on the order of 256 KB (Kilobytes) for large virtual machines, meaning that any change within this range would register as a change of the entire block, regardless of the number of bytes that were actually changed. That is, even if a single bit changes in the said 256 KB block, the entire256 KB block is marked as changed. This results in virtual synthetic backups stitching incremental backups of usually much more data than is actually changed for hypervisors that track changes at coarse CBT levels. It would thus be advantageous to adjust the granularity of these CBT levels to more closely match the actual amount of changed data so as to minimize deduplication processing when generating virtual synthetic backups.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. EMC, Data Domain, Data Domain Restorer, and Data Domain Boost trademarks of Dell Technologies, Inc.

### BRIEF DESCRIPTION OF THE DRAWINGS

In the following drawings, like reference numerals designate like structural elements. Although the figures depict various examples, the one or more embodiments and implementations described herein are not limited to the examples depicted in the figures.

FIG. 1 is a diagram of a computing network implementing a method for enhancing the granularity of filesystem recipes for VM backups, under some embodiments.

FIG. 2 illustrates the composition of a virtual synthetic backup file, under some embodiments.

FIG. 3 illustrates generating a virtual synthetic backup file, under some embodiments.

FIG. 4 illustrates the relationship between the amount of tracked data versus the real changes in a dataset, under some embodiments.

FIG. 5 is a flowchart that illustrates an overall method of processing data to extend the unchanged regions of a filesystem recipe, under some embodiments.

FIG. 6A illustrates an example VS backed up virtual machine with changed data within segments, under an example embodiment.

FIG. 6B illustrates a corresponding filesystem recipe for the files of FIG. 6A, under the example embodiment.

FIG. 7 is a diagram illustrating the enhancement of the granularity of a recipe to more closely match a region of actual changed data, under some embodiments.

FIG. 8 illustrates the adjustment of the CBT region to reclaim some of the changed data area as unchanged data for the example of FIG. 7.

FIG. 9 is a flowchart that illustrates a method of identifying unchanged regions for enhancing the granularity of recipes, under some embodiments.

FIG. 10 illustrates an example of segments in a file section containing fingerprints, under an example embodiment.

FIG. 11 illustrates regions where fingerprints will not match when comparing two files, under an example embodiment.

FIG. 12 is a table illustrating an updated recipe table using the process of FIG. 9, under an example embodiment.

FIG. 13 illustrates the composition of recipes for different unchanged data and split segment regions, under some embodiments.

FIG. 14 is a flowchart that illustrates a method of generating a new overall recipe accounting for unchanged data CBT regions where fingerprint matching is broken by segment splits, under some embodiments.

FIG. 15 is a block diagram of a computer system used to execute one or more software components of the methods and processing component described herein, under some embodiments.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information.

Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the invention.

Some embodiments involve software and systems deployed in a distributed system, such as a cloud based network system or very large-scale wide area network (WAN), metropolitan area network (MAN), however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

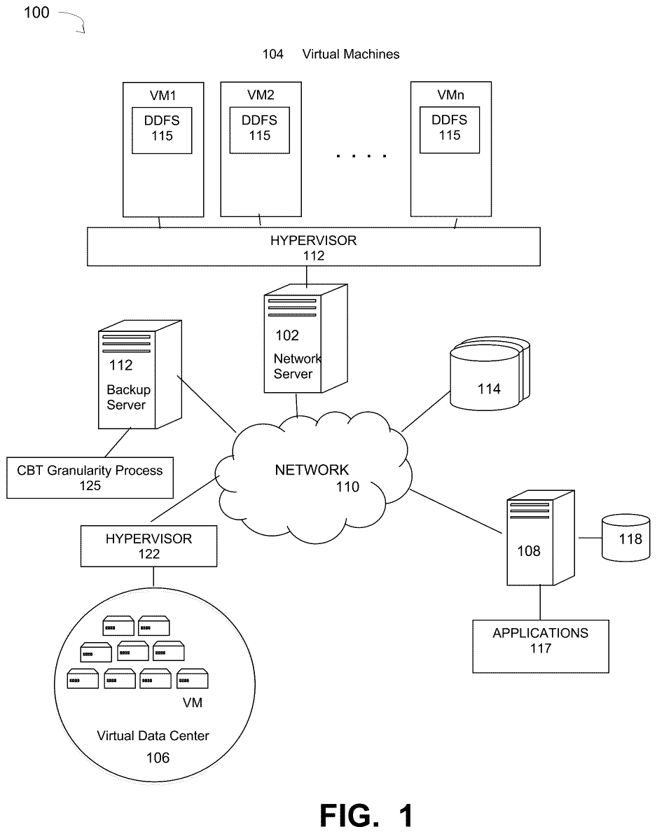

Embodiments are described for a method of enhancing the granularity of changed block tracking (CBT) processes for synthetic backups by extending unchanged regions in a file recipe to more closely match actual changed data. FIG. 1 illustrates a computer network system that implements one or more embodiments of a data processing and storage network system implementing such a process, under some embodiments.

For the embodiment of FIG. 1, network server and client computers are coupled directly or indirectly to one another through network 110, which may be a cloud network, LAN, WAN or other appropriate network. Network 110 provides connectivity to the various systems, components, and resources of system 100, and may be implemented using protocols such as Transmission Control Protocol (TCP) and/or Internet Protocol (IP), as is known in the relevant arts. In a distributed network environment, network 110 may represent a cloud-based network environment in which applications, servers and data are maintained and provided through a centralized cloud computing platform.

In an embodiment, system 100 implements virtualization technology that allows computer resources to be expanded and shared through the deployment of multiple instances of operating systems and applications run virtual machines (VMs). A virtual machine network is managed by a hypervisor or virtual machine monitor (VMM) program that creates and runs the virtual machines. The server on which a hypervisor runs one or more virtual machines is the host machine, and each virtual machine is a guest machine. The hypervisor presents the guest operating systems with a virtual operating platform and manages the execution of the guest operating systems. Multiple instances of a variety of operating systems may share the virtualized hardware resources. For example, different operating system (OS) instances (e.g., Linux and Windows) can all run on a single physical computer.

In an embodiment, system 100 illustrates a virtualized network in which network server 102 runs a hypervisor program 112 that supports a number (n) VMs 104. Network server 102 represents a host machine and target VMs (e.g., 104) represent the guest machines. Target VMs may also be organized into one or more virtual data centers 106 representing a physical or virtual network of many virtual machines (VMs), such as on the order of thousands of VMs each. These data centers may be supported by their own servers and hypervisors 122.

The data sourced within the network by or for use by the target VMs may be any appropriate data, such as database data that is part of a database management system. In this case, the data may reside on one or more hard drives (118 and/or 114) and may be stored in the database in a variety of formats (e.g., XML or RDMS). For example, one computer may represent a database server that instantiates a program that interacts with the database. One or more other servers 108 may also run any appropriate application program 117 that creates, processes, or ingests data within system 100, and an operator of such a server computer may be referred to as a “user.”

The data generated or sourced in system 100 may be stored in any number of persistent storage locations and devices, such as local client storage, server storage (e.g., 118), or network storage (e.g., 114), which may at least be partially implemented through storage device arrays, such as RAID components. In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity drive (optical or magnetic) arrays. In an embodiment, the target storage devices, such as disk array 114 may represent any practical storage device or set of devices, such as fiber-channel (FC) storage area network devices, and OST (OpenStorage) devices. In a preferred embodiment, the data source storage is provided through VM or physical storage devices, and the target storage devices represent disk-based targets implemented through virtual machine technology.

Network 100 of FIG. 1 may implement an enterprise data protection system that implements data backup processes using storage protection devices, though embodiments are not so limited. For this embodiment, backup server 112 executes a backup program that coordinates or manages the backup of data from one or more data sources 108 to storage devices, such as network storage 114, client storage, and/or virtual storage devices 104. With regard to virtual storage 104, any number of virtual machines (VMs) or groups of VMs (e.g., organized into virtual centers) may be provided to serve as backup targets. The VMs or other network storage devices serve as target storage devices for data backed up from one or more data sources, such as storage server 102 or data source 108, in the network environment.

Although embodiments are described and illustrated with respect to certain example implementations, platforms, and applications, it should be noted that embodiments are not so limited, and any appropriate network supporting or executing any application may utilize aspects of the machine learning process for fast forward advance as described herein. Furthermore, network environment 100 may be of any practical scale depending on the number of devices, components, interfaces, etc. as represented by the server/clients and other elements of the network.

In an embodiment, system 100 may represent a Data Domain Restorer (DDR)-based deduplication storage system, and backup (or storage) server 112 may be implemented as a DDR Deduplication Storage server provided by Dell Technologies, Inc. However, other similar backup and storage systems are also possible.

The Data Domain File System (DDFS) from Dell is an example deduplication filesystem in which the filesystem anchors and segments data as it is ingested. The filesystem keeps track of segments which are stored on the disk, and if the segments are accessed again, the filesystem just stores a reference to the original data segment that was written to disk. A file is therefore a stream of segments, and these segments are uniquely identified by a key/label data element, called a fingerprint. Given a file offset and length, the corresponding data segment fingerprints need to be looked up to access the actual data.

DDFS is an inline data deduplication filesystem, wherein, as data gets written to the filesystem, DDFS breaks it into variable sized segments and a group of segments are packed in a compression region. A number of compression regions are grouped together and written as a container to disk. DDFS calculates fingerprint signatures for each segment using SHA1 algorithm. DDFS has an on-disk fingerprint index table, which maps the fingerprint to the container-ID, that has the corresponding segment data. The container has a metadata section followed by several data sections. The data sections store the compression regions; and the container metadata section stores the meta information of the container, i.e., it stores the total number of compression regions, the total number of segments, the fingerprint of each segment, and so on.

In a deduplicated file-system that forms segments from data, these segments are uniquely identified by their key/label called as fingerprint. Given a file offset and length, the corresponding data segment fingerprints need to be looked up. To provide faster offset to fingerprint lookup the mapping is stored in a Merkle tree format where the leaf nodes represent data segments and their fingerprints are stored in the parent nodes which are metadata segments. In a Merkle tree, every non-leaf node is labeled with the hash of the labels of its children nodes to allow efficient and secure verification of the contents of large data structures.

Backup system 100 can implement various different backup operations, such as full backups that copy all the data from a source to a backup storage data, differential backups that backup all data that has changed from a last full backup, and incremental backups that backup only the data that has changed since a previous backup. In a virtualized environment using a hypervisor (e.g., VMware), these backups may be implemented using virtual storage and virtual full or virtual incremental backups. In addition, backups may be synthesized or implemented as synthetic backups, which involve generating a file from a complete copy of the file created in a full backup and one or more incremental copies created later.

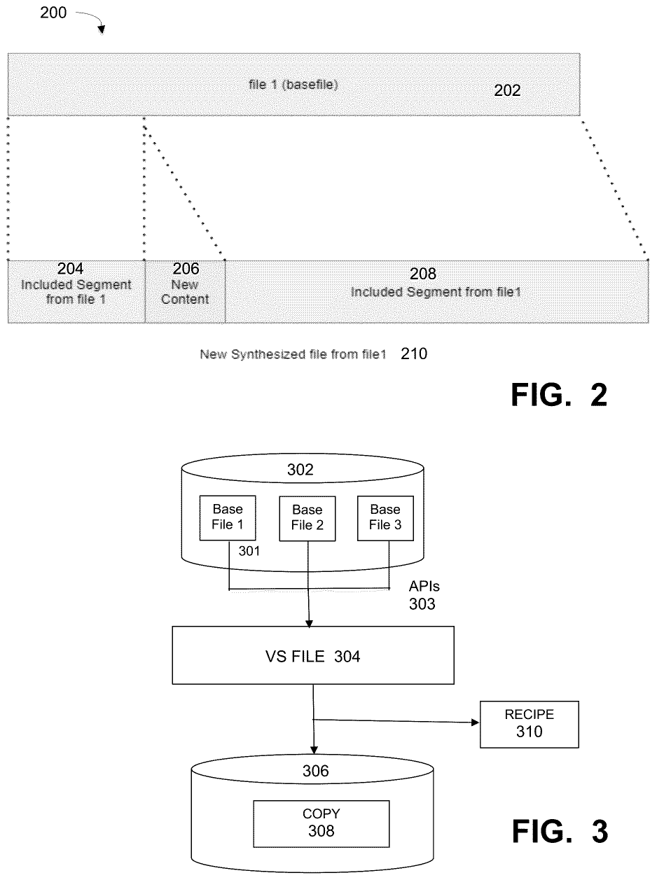

A virtual synthetic process is a backup method where the incremental backup file is stitched on top the last full backup file so that the new backup file includes the portion of the incremental file and the last full backup. Traditionally, the last full backup file is called the base file, and the incremental file is called the increment. FIG. 2 illustrates the composition of a virtual synthetic backup file, under some embodiments. As shown in diagram 200 of FIG. 2, file 1 comprises a base file 202. The synthesized backup process works by incorporating (stitching in) new content 206 among or between other segments 204, 208 of the base file to generate the synthesized backup file 210.

FIG. 3 illustrates generating a virtual synthetic backup file, under some embodiments. As shown in FIG. 3, a source directory or disk 302 stores a number of base files 301 that represent prior generations of a backup. The VS file 304 is created using special APIs (synthetic APIs) 303 to include portions of prior generations of the backup. When the VS file 304 is written to the storage disk 306 and stored as a copy 308, certain metadata is created as a file recipe 310. The recipe 310 comprises a description of the relationship of the target file or copy 308 to a set of prior generations of base files 301, and basically holds information about which portions of the given files are same.

As shown in FIG. 3, DDFS supports virtual synthetic backups using special APIs 303 that can stitch the new file tree to copy portions (Lps) into a new Merkle tree of the VS file 304. Being a deduplication filesystem, this is optimally performed because all that is done is an operation that copies and manipulates metadata. Furthermore, as the filesystem creates the VS files from their base files, it stores the information about the VS files as metadata in the form of recipes 310. This information is used in replication, tiering and diffing, among other possible functions.

In general, a recipe 310 by itself is information about a data extent from a certain file into the given file at the given offset in the current file. The extent is described by the offset in the source file, and the length of the extent. The destination offset is the offset where the source extent is “copied into”. The virtual synthetic backup protocol is flexible in that it allows for includes from several base files instead of just one. Each of the base files referenced is kept in the base file table. The index of the base file in the base file table is used as the base file index in the recipe table.

An example recipe is shown in Table 1 below, which lists a base file index number with the file handle (as metadata).

TABLE 1

| Base file Index | File Handle/Metadata |
|---|---|
| 1 | File1 |

Additional metadata information comprises source and destination offsets and file sizes, as shown in Table 2 below.

TABLE 2

| Base file Index | Source Offset | Destination Offset | Size |
|---|---|---|---|
| 1 | 0 | 100000 | 100000 |
| 1 | 150000 | 10000000 | 9850000 |

This method of including content from another file or files is very flexible. The target file could be a composition from multiple base files, and each could include extents of its own size. The backup application defines the include definition as it is creating the target file, and the application uses DDBoost APIs to inform DDFS of its intent to include a certain segment of the file. The filesystem stores the include relationships using extended attributes and uses these attributes to efficiently replicate the files using the file recipe 310. Using this method, the target file can be created on the replication destination.

The recipe is the metadata information of the relationship between a set of files. The recipe is created as synthetic full backup files are created. The file system tracks the files and extents used to create the file. This metadata is later used to enable efficient diffing, tiering and replication.

The backup software creates a virtual full backup by telling the backup storage system to include segments of data that have not been changed from the prior backup(s), and sends the new segments to be stitched into place. The filesystem, in turn, remembers these included segments as a filesystem recipe. The granularity of the recipe information usually depends on the change tracking on the host. For an embodiment in which the backup software takes a backup of a VM environment, it would track the changes in the vmdk files, such as for VMware hypervisors.

In general, the recipe indirectly references the changed blocks that were tracked by the hypervisor. While a VM is running its data is changing and the hypervisor tracks the areas of change. They hypervisor tracks at a coarser level than the real change. When a backup is taken, the hypervisor provides a list of changed blocks, i.e., the areas that have changed from a prior point in time). A virtual synthetic backup finds all the regions that have not changed (i.e., anything not in the changed blocks) and these regions can be copied from the last backup. As VS calls are made to carry forward unchanged areas, each unchanged area saved in the recipe. In the case of VM backups, the recipe represents all areas/regions that have not changed and will only reference one base file.

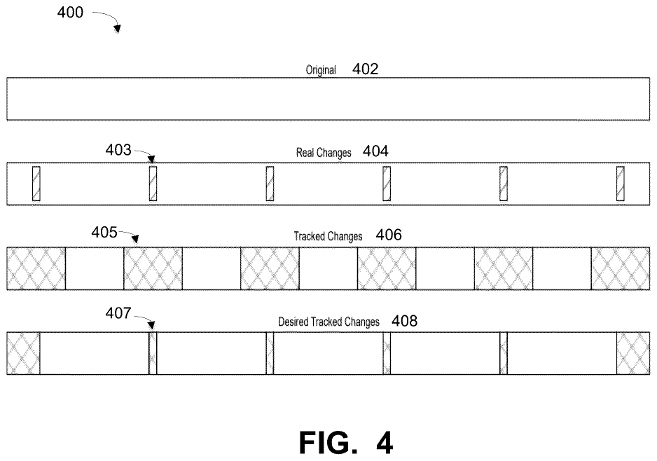

The CBT system tracks the changes at a certain granularity. The granularity of the CBT is set by the hypervisor and dictates the amount of change data being tracked. FIG. 4 illustrates the relationship between the amount of tracked data versus the real changes in a dataset, under some embodiments. Diagram 400 of FIG. 4 illustrates an original dataset 402, which could be the size of an entire VM that is to be backed up. This dataset could be of a size on the order of Gigabytes or Terabytes, such of a size of 1 TB to 16 TB, etc. Between backups, at least some of the original data is changed. For the example of FIG. 4, it is shown that the real changed data 403 of the original 402 occurs at certain intervals and of a relatively small amount compared to the file as a whole. The CBT process sees these changes and generates tracked changes 405. The area of each of these blocks is larger than the real change size 403 because of the set granularity of the CBT in the hypervisor. The hypervisor providing a larger region as changed creates inefficiencies in backup operations. For a deduplication filesystem, the impact of a bigger granularity is that more segments must be filtered during deduplication.

Embodiments of a CBT granularity process 125 executed by backup server 112 increases the size of the blocks being recorded in the recipe, as this is the area that did not change, to more closely align with the actual changed data, such as shown as the desired tracked change areas 407, which are correspond much more closely to the actual changes 403 than the tracked changes 405.

The CBT amount is typically proportional to the size of the entire VM dataset, and a larger dataset results in a larger amount of tracked data, i.e., a coarser granularity. For the example shown in FIG. 4, if the original dataset size 402 is 1 TB, the CBT area 405 could be on the order of 256 KB, likewise for area 402 (e.g., 16 TB), the CBT area 405 would be proportionately larger as well, e.g., up to 1 MB or more. This means that if only a small amount of data 403 is actually changed, such as on the order of only a few bytes or kilobytes, the entire CBT area would still be used in the filesystem recipe, thus resulting in a large amount of data that actually does not need to be processed during deduplication and replication.

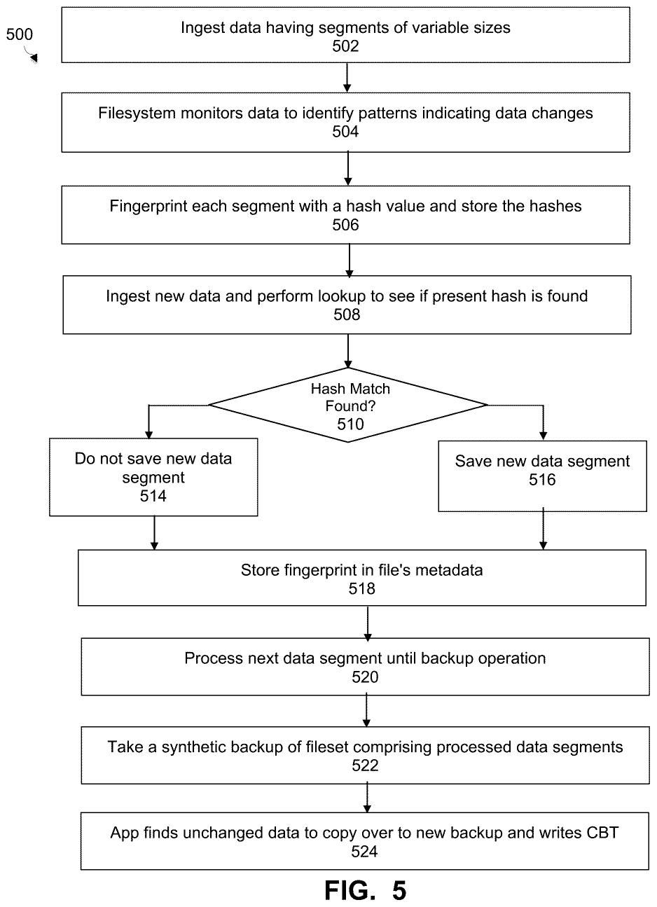

FIG. 5 is a flowchart that illustrates an overall method of processing data to extend the unchanged regions of a recipe, under some embodiments. For a DDFS system, data within files are chunked into segments of variable sizes during ingest, where the segments are based on the content of the data, 502. The filesystem monitors the data and looks for a specific pattern indicated changed data within any of the segments, 504.

Each of the segments is represented by a fingerprint comprising a hash generated by hash process (e.g. SHA1 or SHA2), which are then stored for comparison, 506. As new data is ingested, a lookup is performed to determine if the hash for a new segment matches any of the stored hash values, 508. If yes, this indicates duplicate data for the new segment, and there is thus no need to store the segment data, 514. The fingerprint will be stored within the file's metadata, 518, but the data itself is not needed since it already resides on the system. If the hash is not found in step 510, the new data segment is saved, 516, and the fingerprint will be stored in the file's metadata, step 518. Each data segment is processed through these fingerprinting steps until a backup operation is executed, 520, at which time the system takes a synthetic backup of the fileset containing all of the processed data segments, step 522.

As shown for process 500, a file is made up of segments where each segment has a fingerprint. When the application creates a VM (as the fileset) backup using virtual synthetic backups, the application identifies unchanged portions of the previous backup file to copy over to the new backup, and it writes CBT data directly, step 524. It creates the file, from start to finish, interleaving these steps.

As shown in FIG. 5, as the data is written it is broken down into segments with identifying fingerprints, and is processed using the fingerprint filtering method described in process 500. For unchanged data, as in step 516, the segment data itself from existing files is not copied over, however the fingerprints are recorded in the new files' metadata, 518. It should be noted that the ranges being copied may not align on the original file's segment boundaries and this results in new segments being created due to a split of the original segment, and new fingerprints.

The size of the CBT region processed in step 524 is a fixed value set by the hypervisor, which in turn depends on the size of the VM that is being backed up. In general, a hypervisor tracks changes in a certain number of bits and the value of a bit becomes coarser as the VM becomes bigger. That is, a large VM size results in large CBT region sizes. For example, a 1 TB (Terabyte) VM may use require a CBT region of length 256 KB, a 2 TB VM may require 512 KB CBT region, a 4 TB VM may require 1 MB, and so on. In many cases the application driven changed content is very small compared to the CBT regions being written. In this case, much of the CBT region will be deduplicated, even though very little data within the region may have changed. In an embodiment, the deduplication process is optimized to deduplicate data much more closely matching the actual changed data in a CBT region through process 125 of FIG. 1.

A filesystem recipe captures which portions of the file were synthesized (unchanged from the base file), and tabulates this data in terms of filename, source (src), destination offset (dest offset), and length.

The illustration below shows a VM Image backup (File-1) where 256 KB is defined as the CBT size. Every other block has a 16 KB change within it. The remaining data is unchanged from File-0 so simply synthesized over.

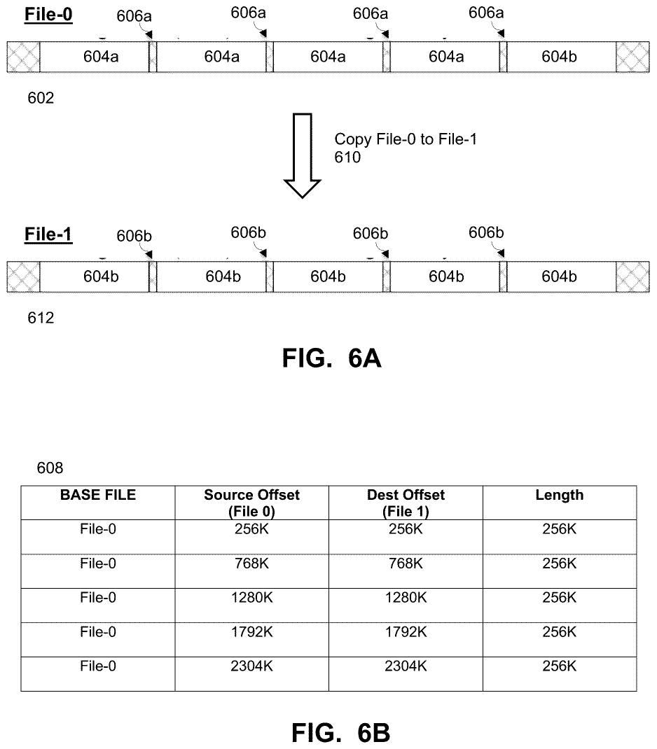

FIG. 6A illustrates an example VS backed up virtual machine with changed data within segments, under an example embodiment. As shown in FIG. 6, an original file 602, named “File-0” (and which may represent an entire VM), has a number of changed regions 604a and unchanged regions 606a. File-0 represents the state of the entire VM on a certain day, and it is then copied to produce a copied file, “File-1,” 612. This file should have the same unchanged and changed areas, as denoted 604b and 606b.

FIG. 6B illustrates a corresponding filesystem recipe for the files of FIG. 6A, under an example embodiment. The recipe 608 provides the way to construct a particular file given just offset and length information. In the case of synthetic backups, this is all that is needed since the amount of unchanged data between original and copied files does not need to be explicitly defined. The recipe 608 specifies the base file (in this case File-0) that is copied to make the copied file (File-1). The source offset (e.g., 256K) specifies the location of the first unchanged data, and the length is a multiple of minimum trackable size, and is of a fixed length as dictated by the hypervisor, i.e., it does not change even if the actual amount of changed data is smaller than the stated length.

The data between 0 and 256K is changed data, as is the area between 512K and 768K, where the source offset specifies that starting at 256K for a length of 256K (512K), there is at least some changed data. This value defines the extents of the changed area where an extent=offset+length. The synthetic backup is produced by taking these unchanged areas between the extents and applying the changes brought by File-1.

In recipe 608, the destination offset specifies the location of the first changed data in the copied file (File-1). The example of FIGS. 6A and 6B illustrate a case of VM copying, where the source and destination offsets will be the same value, that is, there is no right or left shift in the copied file, and only one base file.

The corresponding file recipe thus captures the backup synthesized regions, i.e., the regions that do not change between the original file and the copy. For this example, the original file (File-0) has a 16 KB change of data in every other 256 KB block, for a total file size of 2816 KB. An application would use this table to determine that 1280K bytes were synthesized, so 1536K bytes is new or changed data. However, in this case it should be noted that only 96K bytes changed (16 KB within alternating 256 KB regions). This extraneous amount of data considered to be changed is due to the set length of 256 KB, as imposed by the hypervisor. As the VM size increases, this length value will also increase, such as up to 512 KB or 1 MB, as described above.

Embodiments of process 125 in FIG. 1 extend the extent sizes in the recipe table to more accurately reflect the size of the unchanged data. It does this by enhancing the granularity of recipes for variable size segmenting (VSS) to create VM backups after ingesting data into a deduplication file system. It basically corrects the coarse level of tracked changes imposed by the hypervisor.

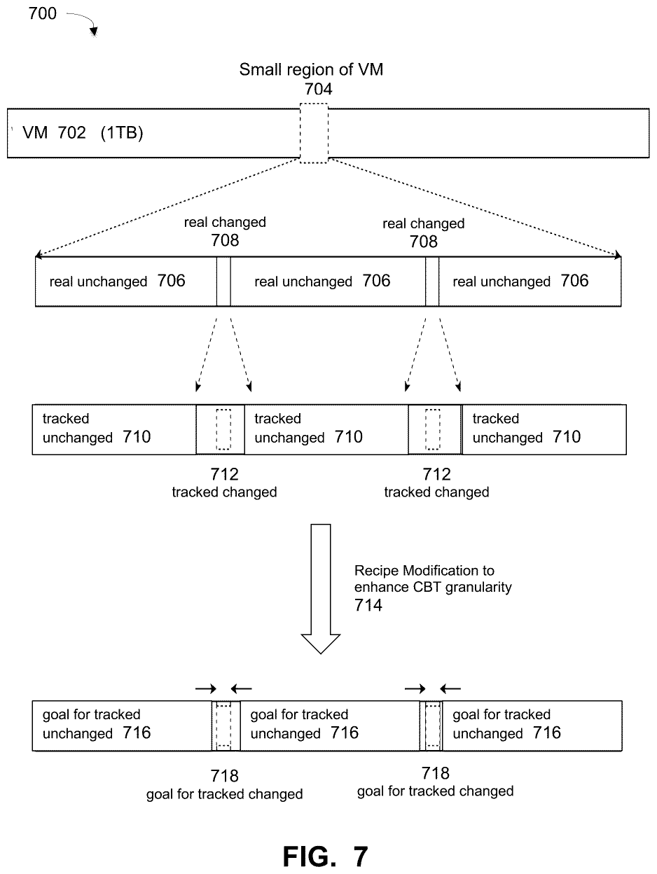

FIG. 7 is a diagram illustrating the enhancement of the granularity of a recipe to more closely match a region of actual changed data, under some embodiments. Diagram 700 shows a VM 702 having a size of 1 TB, or any other similar size with a small region of focus, 704. This region includes real unchanged data 706 interspersed with regions of real changed data 708 so that a segment of alternating changed and unchanged data is formed. When the VM 702 is copied in a deduplication system such system 100 of FIG. 1, the CBT process identifies the real changed sections 708 and marks the CBT region around this data as tracked changed 712. For the example of FIG. 7, it is presumed that the amount of real changed data 708 is less or significantly less than that of the CBT tracked change region 712, though not drawn to scale, a typical value for a 1 TB VM might be a tracked change area of 256 KB (corresponding to the CBT granularity), while the real changed data may less than 64 KB, meaning that 192 KB within the tracked changed area 712 is not actually changed, however the CBT process still marks this entire area as changed data. This extra data represents what can be a significant amount of “bloat” to the deduplication backup system as it is all deduplicated as if it was all changed data.

Applying a recipe modification process of component 125 in system 100 helps achieve a more accurate granularity of the tracked unchanged area and tracked change area in terms of conforming the desire or goal for the unchanged regions 716 and goal for the changed regions 718 more closely to the real regions 706 and 708. In this way, the system counteracts the bloat introduced by the CBT process, which expands the tracked change area to the rigidly set and often overly large hypervisor CBT region.

The small region 704 within the VM 702 represents any amount of data, and it should be understood that the entire backed up VM comprises a very high number of such regions, depending on its size. Thus, the entire backup copy may need to process very high numbers of interspersed changed and unchanged segments.

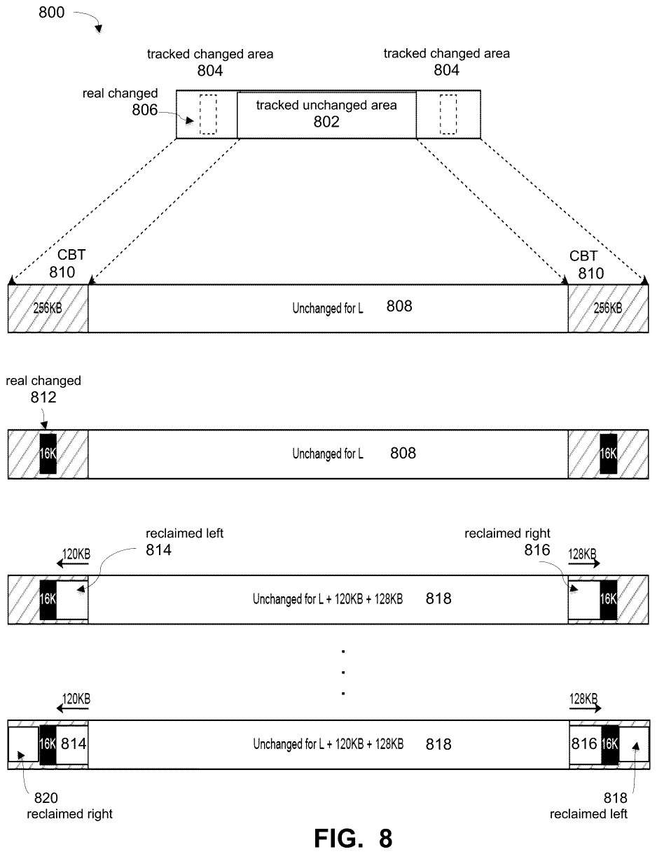

FIG. 8 illustrates the adjustment of the CBT region to reclaim some of the changed data area as unchanged data for the example of FIG. 7. Diagram 800 of FIG. 8 shows an example region comprising a tracked unchanged area 802 in between two tracked change areas 804 that each contain real changed data of area 806, which is less than the tracked change area 804. The tracked change area 804 is the CBT region 810 and is of 256 KB for the example of FIG. 8, and which straddle the unchanged data 808, which has a length L. Within each CBT regions is a 16 KB of real changed data 812, as shown.

The example of FIG. 8 illustrates these real changed data to be approximately centered in the CBT area, but it could be anywhere within the CBT region, such as closer to one edge or the other. The CBT process only knows that some data within the region has changed, but does not give any indication of where that data is located within the CBT region. Likewise a real changed region may stretch across a 256 KB CBT boundary so that two adjacent CBT regions are created.

Embodiments of process 125 detect the locations and boundaries of the real changed data 812 within the CBT region 810 and extend the unchanged area 808 to essentially reclaim the actual unchanged area within the CBT region to be part of the unchanged area. This is shown in FIG. 8 as reclaimed region 814 to the left and reclaimed region 816 to the right of unchanged area 808. Reclaiming these regions yield an actual unchanged area to be length L+120 KB+128 KB as shown. In this example, the left and right real changed data regions were in slightly different locations within their respective CBT regions, and the net reclamation is on the order of 228 KB within the total 512 KB combined CBT regions 810.

FIG. 8 illustrates the reclamation of tracked changed areas to the left and right of the unchanged area 808, and it should be understood that this process can be repeated to the left and right of the CBT regions 810 along the entire file or VM that is being backed up. Thus, as shown in FIG. 8, another reclaimed region 820 may be the reclaimed right area for a unchanged area to the left of 818 and further reclaimed region 818 may be the reclaimed left area for a unchanged area to the right of 818, and so on for the entire VM 702.

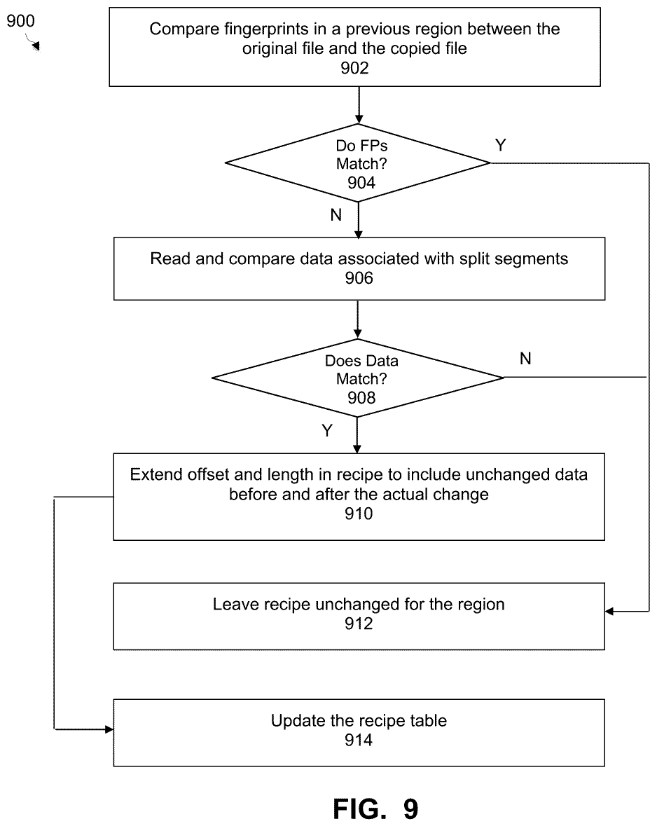

FIG. 9 is a flowchart that illustrates a method of identifying unchanged regions for enhancing the granularity of recipes, under some embodiments. The identification step uses the fingerprints that comprise the segments in the original and copied files. Process 900 of FIG. 9 begins with comparing fingerprints in a previous region between the original file (File-0) and the copied file (File-1), step 902. For example, the fingerprint data in the 256 KB block prior to the synthesized region will be retrieved from File-0 and compared to fingerprints for the same region in File-1.

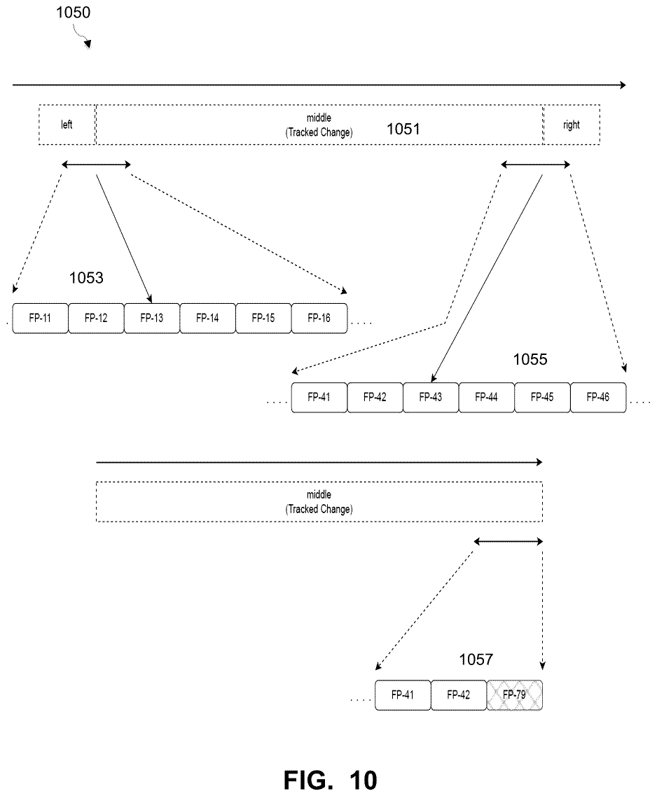

FIG. 10 illustrates an example of segments in a file section containing fingerprints, under an example embodiment. FIG. 10 is provided for purposes of illustration only and any other composition is possible. Diagram 1050 of FIG. 10 shows a section of a file to be copied with a middle (tracked change) region 1051. This region has a left and right portion each having a set of fingerprints 1053 (encompassing fingerprints FP-11 on) and 1055 (encompassing fingerprints FP-41 and on). During a comparison of this region between an original and copied file, at least some of these fingerprints may not match, as shown for fingerprint set 1057 in which fingerprint FP-79 is a non-matching fingerprint.

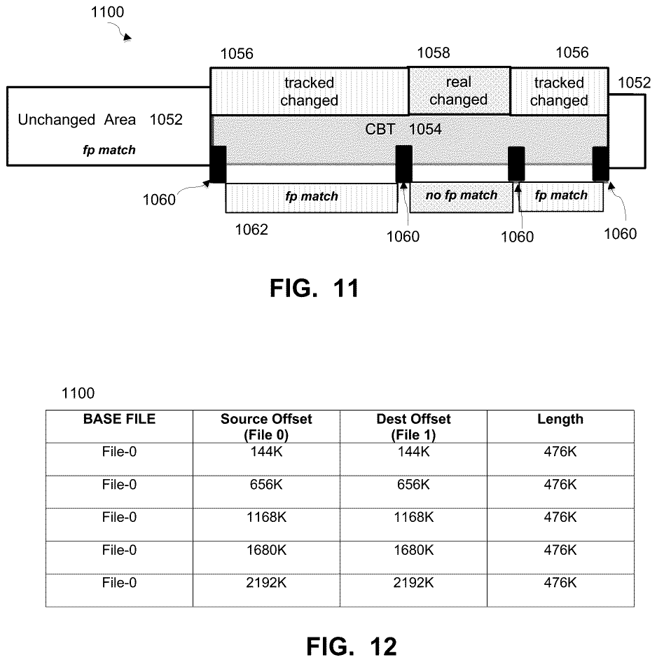

The fingerprints will not match in a few different circumstances. The first is within a real changed area, such as 812, and in the segment change junction between the CBT area 810 and the unchanged area 808. Fingerprints will also not match in the segment change junction between the changed area 812 and the remaining CBT region 810. FIG. 11 illustrates these regions where the fingerprints will not match. Diagram 1100 of FIG. 10 shows a CBT region 1054 between two unchanged areas 1052. As before, this region may be of a size 256 KB, and contain a real changed area 1058 (e.g., 16 KB) and tracked changed areas 1056 on either side of 1058 that actually contain unchanged data.

Fingerprints will not match in the real changed area 1058, but they will match in the tracked changed areas 1056. However, at each junction in between these areas are smaller areas 1060 where fingerprints will not match as well. This is because the transitions between the unchanged and CBT areas causes a loss of synchronization of the deduplication processes.

The decrease in size between the tracked change area 1056 and the tracked change area 1062 where the fingerprints match is due to the fact that it is the fingerprints that are being used to compare the data, and not the data itself. Because the fingerprints are being processed, there is a certain area 1060 where the fingerprints do not match, even though the underlying data may not change. The fingerprint comparison relies on continuity across the entire segment and the junctures between the different regions in FIG. 11 represent places where this continuity is broken, causing the fingerprint comparisons to return no match until they are again re-synchronized to the original fingerprints. This synchronization may take on the order of one to five fingerprint comparisons before the comparisons return fingerprint matches in fingerprint anchoring or re-anchoring process for VSS processing.

For the example of FIG. 10, the segment change areas 1060 include the two transitions from unchanged area 1052 to CBT 1054 and back to unchanged area 1052, and the two transitions from the tracked change are 1056 to the real changed area 1058 and back to the tracked change area 1056. The areas on either side of these transitions are areas where the fingerprints (fps) match as shown by the regions marked “fp match,” except for the real changed area 1058, where the fingerprints do not match due to the actual change in data between the original and copy files.

As shown in FIG. 9, process 900 determines whether or not the compared fingerprints match for the previous region. If they do match, the file recipe to construct the copy from the original is left unchanged, 912. If however, they do not match, the process reads and compares the data associated with the split segments 1060, step 906. As shown in FIG. 9, this could occur in any of the split segment areas 1060 or within the real changed area 1058.

Referring back to the example of FIG. 8 the fingerprints will begin to match shortly after the 16 KB change 812, beginning at roughly 128K bytes back (corresponding to area 816). The fingerprint at the point the synthesized region 808 begins will likely not match because it is a split segment from the original data. This is represented by the small black regions 1060 that remain adjacent to the unchanged area(s) 1052.

In step 906, the process reads and compares the data associated with the split segments. The actual data will be read for this smaller split segment region from File-0 and File-1. If the data is the same, as in this example, the recipe extent can be expanded to include the region of data going back to where the real changed data update was introduced, step 910. Otherwise, the recipe is left unchanged for this region, 912.

FIG. 10 illustrates the fact that since the data is ingested with Variable Size Segmenting (VSS), the segments that represent this data, and the corresponding fingerprints, will not align exactly with the original data. The small regions 1060 in FIG. 11 are meant to identify these junctures.

In a DDFS system, a segment size averages 8K in present deployments. The 16K real changed region 1058 would thus fall into approximately two to three DDFS segments. Since the segment breakdown is dependent on the data itself, it will likely require more data to be processed before fingerprints of the unchanged data will begin to match that of the original data. The read and compare step 906 is meant to compare the smaller regions between the synthesized data, and the data before and after it was determined to be unchanged by the fingerprint comparison in step 902. If the data matches, as in this example, the offset and length in the recipe record can be extended to include the unchanged data before and after the actual change. At this point, the recipe table is updated, step 914.

FIG. 12 is a table 1100 illustrating an updated recipe table using the process 900, under an example embodiment. This recipe captures the synthesized region as expanded to include the reclaimed unchanged data areas within the CBT regions. With the expanded recipe information, File-1 is made up of approximately 2380K bytes of unchanged data. The changed data to be read or compared for replication or scanning purposes is reduced to only 436K bytes.

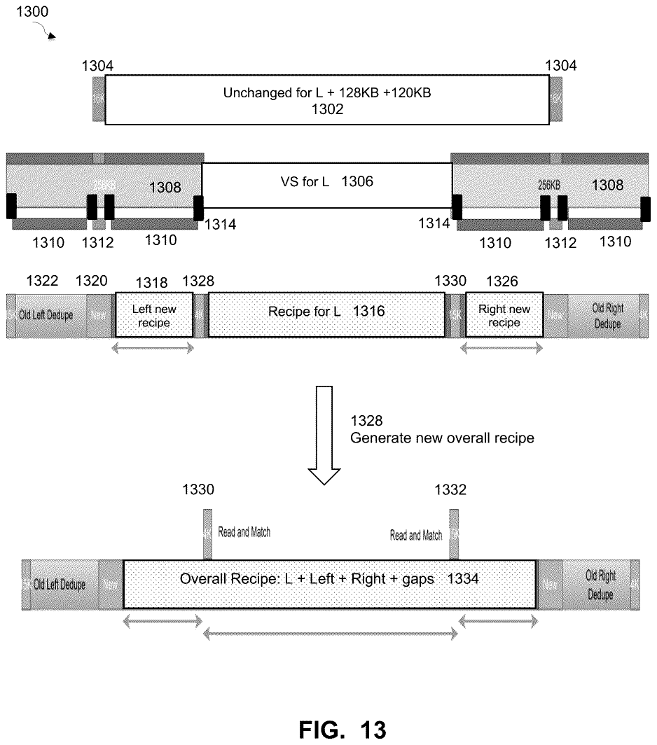

FIG. 13 illustrates the composition of recipes for different unchanged data and split segment regions and generation of new overall recipe, under some embodiments. Diagram 1300 shows an extended unchanged area 1302 bordered by two changed areas 1304, as described in FIG. 8 with the derivation of region 818 including the reclaimed areas 814 and 816.

In FIG. 13, this area is generated by the unchanged length L, 1306 and the right and left unchanged data portions of the CBT regions 1308. These regions are composed of alternating no-change 1310, change 1312, and split segment 1314 fingerprint regions, such as shown and described in FIG. 11. Because of loss of synchronization caused by the segments splits, a single recipe cannot be generated for the entire unchanged data area 1302. Process 125 includes a mechanism to accommodate these discontinuities, however. As shown in FIG. 13, individual recipes are generated for each synchronized fingerprint no change area for this overall segment of 1306 plus the CBT regions 1308. A recipe is generated (using the CBT process) for the main unchanged data area of length L, 1316, and then a new recipe 1318 is generated for the left side in the unchanged area between the real changed area 1320 and the small no-match (un-anchored) segment split area 1328. Likewise, a new recipe is generated for the right side in the same manner. For purposes of illustration, the CBT area is assumed to be 256K with reclaimed areas of 128 KB and 120 KB as in the earlier examples, while the segment areas 1328 and 1330 are shown to be on the order of 4K and 15K, respectively. Other values are possible, however.

A process to generate a new overall recipe 1328 combines these three recipes by performing a read and match operation on the data (as opposed to the fingerprints) in the small split segment areas 1328 and 1330. This is shown as read and match operations 1330 and 1332. Because the no match is caused by the re-anchoring of fingerprints, and not a change in the underlying data (as compared to the actual no match area 1320), the data here will match, and thus the recipe can generated over these combined areas. This is shown as recipe 1334 that combines the recipes 1316, 1318, and 1326.

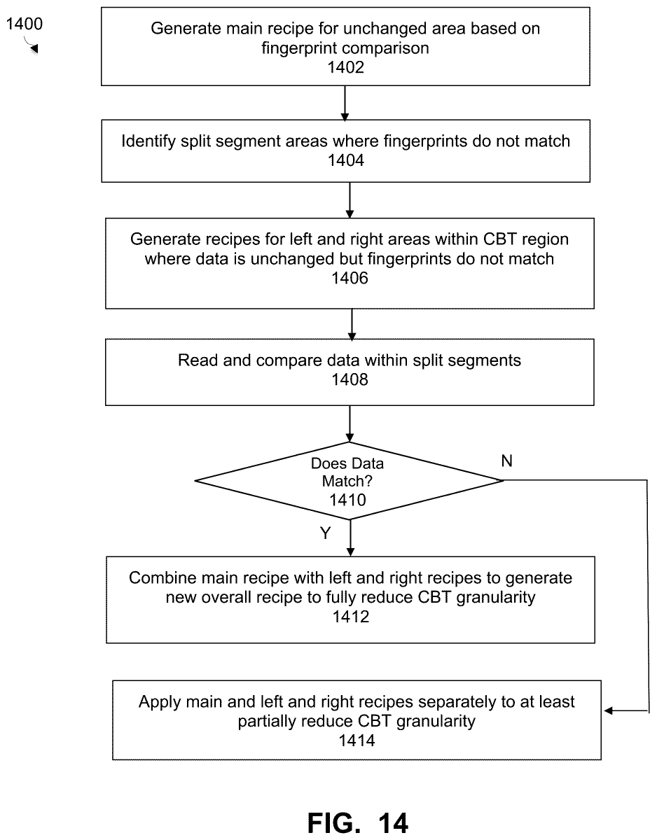

FIG. 14 is a flowchart that illustrates a method of generating a new overall recipe accounting for unchanged data CBT regions where fingerprint matching is broken by segment splits, under some embodiments. Process 1400 begins with generating a main recipe for the unbroken and unchanged data area (e.g., 1306) based on a fingerprint comparison, step 1402. It then identifies split segment areas (e.g., 1328, 1330) where the fingerprints do not match due to VSS non-synchronization, step 1404. On either side of these split segments are CBT regions where there are likely at least some area where the data is unchanged (e.g., 1310). The process then generates the recipes (1318, 1326) for these areas, step 1406. The data within split segments (1330, 1332) are then read and compared between the original and copied files, step 1408. If, in step 1410, it is determined that the data matches, these areas are then considered to be part of the main unchanged data area (1302), and a new overall recipe is then generated by combining the recipes for the main area along with the left and right side recipes, step 1412. This recipe covers the entire unchanged area 1302 up to or in between the real changed data areas 1304, and keeps the unchanged area totally contiguous.

If the data in the split segment areas does not match in step 1310, the process applies the main and left/right recipes separately, and the data within small split segment regions (1328, 1330) is sent across to the target for deduplication, step 1414.

The process of FIG. 14 thus combines comparisons of fingerprints over large area and a comparison of data, but over a much smaller area (e.g., 19K for FIG. 13) to fill in the gaps in the recipes caused by split segments and VSS fingerprint re-anchoring. This process finding and reading data from the split segment regions (e.g., 4K and 15K) does not add any excessive processing overhead because this data needed to be read anyway to send the data over the network for during replication. In this manner, the processing is performed up front to potentially save any later processing and transmission of what is actually duplicate data. Split segments are typically quite small, such as on the order of 4 KB to 12 KB, or similar depending on system configuration.

Embodiments thus described provide a method to identify unchanged data regions within larger CBT backup blocks, and using this to extend a file's recipe record in order to reduce the effective CBT granularity. This enables a more efficient synthetic replication workflow where only changed blocks are sent for deduplication operations. By reducing the size of the changed regions in the recipe file, less data is replicated over the wire to the target system.

Embodiments of the processes and techniques described above can be implemented on any appropriate backup system operating environment or filesystem, or network server system. Such embodiments may include other or alternative data structures or definitions as needed or appropriate.

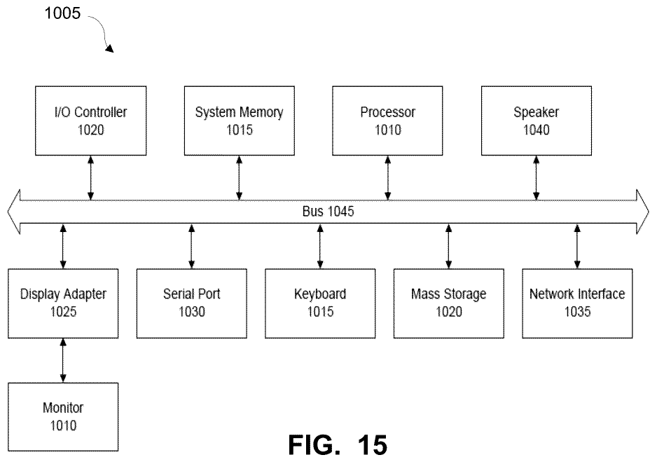

The network of FIG. 1 may comprise any number of individual client-server networks coupled over the Internet or similar large-scale network or portion thereof. Each node in the network(s) comprises a computing device capable of executing software code to perform the processing steps described herein. FIG. 15 shows a system block diagram of a computer system used to execute one or more software components of the present system described herein. The computer system 1005 includes a monitor 1011, keyboard 1017, and mass storage devices 1020. Computer system 1005 further includes subsystems such as central processor 1010, system memory 1015, I/O controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1005. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1005 is only one example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system 1005 may be one of the Microsoft Windows®. family of systems (e.g., Windows Server), Linux, Mac OS X, IRIX32, or IRIX64. Other operating systems may be used. Microsoft Windows is a trademark of Microsoft Corporation.

The computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (e.g., IEEE standards 802.x), near field communication (NFC), radio-frequency identification (RFID), mobile or cellular wireless. For example, signals from a computer may be transferred, at least in part, wirelessly to components or other computers.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of optimizing a filesystem recipe for virtual machine (VM) backups using variable size segmenting (VSS), comprising:
identifying a region of a VM to be copied having an unchanged data area bounded by left and right regions of real changed data;
applying a changed block tracking (CBT) process to mark a CBT region as changed data, wherein the regions of real changed data are subsets of respective CBT regions;
identifying areas within the respective CBT regions that have unchanged data that is marked as changed data by the CBT process; and
extending a recipe specifying unchanged data of a base file for replication to include the identified areas so as to prevent replication of data that is actually unchanged but marked as changed by the CBT process.

2. The method of claim 1 wherein the recipe is generated by a synthetic backup operation making a virtual synthetic (VS) copy of an original VM to generate the copied VM, and wherein the recipe comprises a filesystem recipe consisting of metadata specifying how to generate the copied VM.

3. The method of claim 2 wherein the replication or synthetic backup is performed by backup software in a deduplication backup system comprising a data storage server running a Data Domain File System (DDFS) and a virtualization component comprising a hypervisor.

4. The method of claim 3 wherein the VM is on the order of Terabyte size, and the CBT region is of a size of 256 KB or more, and further wherein the CBT region is strictly set by the hypervisor.

5. The method of claim 3 wherein data of the VM comprises a plurality of segments, each segment containing a fingerprint generated by a hash process of the deduplication backup system.

6. The method of claim 1 wherein the extending step comprises:
comparing fingerprints within segments of the area of real unchanged data within the CBT region between the original VM and copied VM; and
adding, if the compared fingerprints match, the segments of the compared fingerprints to segments of the unchanged data area to generate an extended unchanged area.

7. The method of claim 6 further comprising identifying split segment areas having non-matching fingerprints created by lack of synchronization of fingerprints in a discontinuity between the CBT area and the unchanged data area, and wherein re-anchoring of the fingerprints between unchanged data between the original VM and copied VM will remedy the lack of synchronization.

8. The method of claim 7 further comprising:
comparing data within split segment areas between the original VM and copied VM; and
adding, if the compared data matches, the segments of the compared split segments to segments of the extended unchanged data area to generate a fully extended unchanged data area.

9. The method of claim 8 further comprising generating the recipe to specify extents and lengths of segments to build the copied VM from fully extended unchanged data areas.

10. The method of claim 9 wherein a granularity of the CBT process is effectively reduced by a total amount of area reclaimed from the CBT region for the actually unchanged but marked as changed data, and wherein this total amount prevents deduplication of the actually unchanged data by the backup software.

11. A computer-implemented method of optimizing a filesystem recipe for virtual machine (VM) backups using variable size segmenting (VSS), comprising:
generating a recipe to copy a region of a VM having a unchanged data area bounded by regions of real changed data, wherein the region comprises a plurality of segments and the changed data is detected and marked by a changed block tracking (CBT) process that defines a changed data region as a superset of a real changed data region;
copying the VM from an original VM to a copied VM using a deduplication backup program that produces fingerprints for each segment by hashing data in each respective segment;
performing a fingerprint comparison to first identify areas within the changed data region that have unchanged data; and
first extending the recipe to include the first identified areas in an extended recipe.

12. The method of claim 11 further comprising:
finding split segment areas having non-matching fingerprints created by lack of synchronization of fingerprints in a discontinuity between the changed data region and the unchanged data area, and wherein re-anchoring of the fingerprints between unchanged data between the original VM and copied VM will remedy the lack of synchronization; and
performing a data comparison within split segment areas between the original VM and copied VM to second identify areas within the split segment area that have unchanged data for the non-matching fingerprints; and
second extending the recipe to include the second identified areas in a fully extended recipe.

13. The method of claim 12 wherein each recipe including the extended and fully extended recipes defines data segments having an offset and length to write the changed data of the CBT region over unchanged data in the unchanged data area for a synthetic backup for an original VM to a copied VM.

14. The method of claim 13 wherein the deduplication backup is performed by a deduplication backup system comprising a data storage server running a Data Domain File System (DDFS) and a virtualization component comprising a hypervisor, and further wherein the CBT region is strictly set by the hypervisor.

15. The method of claim 14 wherein the VM is on the order of Terabyte size, and the CBT region is of a size of 256 KB or more, and yet further wherein the split segment area is on the order of 4 to 12 KB.

16. The method of claim 13 wherein a granularity of the CBT process is effectively reduced by a total amount of area reclaimed from the CBT region for the actually unchanged but marked as changed data, and wherein this total amount prevents replication of data that is actually unchanged but marked as changed by the CBT process.

17. A system optimizing a filesystem recipe for virtual machine (VM) backups using variable size segmenting (VSS), comprising:
a first component generating a recipe to copy a region of a VM having a unchanged data area bounded by regions of real changed data, wherein the region comprises a plurality of segments and the changed data is detected and marked by a changed block tracking (CBT) processing component that defines a changed data region as a superset of a real changed data region;
a deduplication backup server copying the VM from an original VM to a copied VM using a backup process that produces fingerprints for each segment by hashing data in each respective segment;
a second component performing a fingerprint comparison to first identify areas within the changed data region that have unchanged data, and first extending the recipe to include the first identified areas in an extended recipe.

18. The system of claim 17 further comprising a third component finding split segment areas having non-matching fingerprints created by lack of synchronization of fingerprints in a discontinuity between the changed data region and the unchanged data area, and wherein re-anchoring of the fingerprints between unchanged data between the original VM and copied VM will remedy the lack of synchronization, and wherein the deduplication backup server further performs a data comparison within split segment areas between the original VM and copied VM to second identify areas within the split segment area that have unchanged data for the non-matching fingerprints, and yet further wherein the second component second extends the recipe to include the second identified areas in a fully extended recipe.

19. The system of claim 18 wherein each recipe including the extended and fully extended recipes defines data segments having an offset and length to write the changed data of the CBT region over unchanged data in the unchanged data area for a synthetic backup for an original VM to a copied VM.

20. The system of claim 19 wherein the deduplication backup server runs a Data Domain File System (DDFS) and a virtualization component comprising a hypervisor, and the CBT region is strictly set by the hypervisor, and further wherein the VM is on the order of Terabyte size, and the CBT region is of a size of 256 KB or more, and yet further wherein the split segment area is on the order of 4 to 12 KB.
